(19) United States
(12) Patent Application Publication
(10) Pub. No.: US 2018/0375145 A1
(43) Pub. Date: Dec. 27, 2018

(54) ELECTRODE PLATE AND BATTERY

(71) Applicant: FDK CORPORATION, Tokyo (JP)

(72) Inventors: Yuki Ochiai, Tokyo (JP); Naoaki Nishimura, Tokyo (JP); Daisuke Hirata, Tokyo (JP); Keita Yamamoto, Tokyo (JP)

(73) Assignee: FDK CORPORATION, Tokyo (JP)

(21) Appl. No.: 16/013,948

(22) Filed: Jun. 21, 2018

(30) Foreign Application Priority Data
Jun. 23, 2017 (JP) 2017-122849

(51) Int. Cl. H01M 10/04; H01M 10/0525; H01M 4/36

(52) U.S. Cl. CPC H01M 10/045; H01M 4/36; H01M 10/0525

(57) ABSTRACT

An electrode plate constituting a positive electrode or a negative electrode of a battery and having a flat plate shape including a sheet-shaped current collector made of metal foil and coated with a slurry electrode material containing an electrode active material, a conductive auxiliary agent, a binder, and a thickener, the thickener being propylene glycol alginate.

### CROSS-REFERENCE TO RELATED APPLICATION

The present application claims priority pursuant to 35 U.S.C. § 119 to Japanese Patent Application No. 2017-122849 filed on Jun. 23, 2017 in the Japan Patent Office, the entire disclosure of which is hereby incorporated herein by reference.

### BACKGROUND

### Technical Field

This disclosure relates to an electrode plate and a battery.

### Background Art

A battery is known in which power-generating elements are accommodated inside a casing having a flat shape like that of a flattened bag or flattened box. This type of battery includes a flat plate-shaped positive electrode plate as a positive electrode, the positive electrode plate being formed by coating a slurry positive electrode material on a sheet-shaped current collector made of metal plate or metal foil and drying it. The battery also includes a flat plate-shaped negative electrode plate as a negative electrode, the negative electrode plate being formed by coating a slurry negative electrode material on a sheet-shaped current collector made of a metal plate or metal foil and drying it. In the following description, the positive electrode and the negative electrode are also collectively referred to as electrodes. Moreover, the positive electrode plate and the negative electrode plate are also collectively referred to as electrode plates. Furthermore, the positive electrode material and the negative electrode material are also collectively referred to as electrode material. As a battery including such electrode plates, a laminated battery is well known.

### SUMMARY

A battery having a flattened bag-shaped or a flattened box-shaped casing, such as a laminated battery, includes electrode plates in which a slurry electrode material is coated on sheet-shaped current collectors made of metal foil or a metal plate. The slurry electrode material is produced by adding a binder to a powdery electrode active material and a conductive auxiliary agent and kneading them using a mixer such as a planetary mixer.

More specifically, the slurry electrode material that constitutes an electrode plate is produced by kneading together a mixture of the powdery electrode active material, the conductive auxiliary agent, the binder, and a thickener as necessary, using a mixer such as a planetary mixer to apply shearing stress thereto. If an organic solvent such as N-Methyl-2-pyrrolidone (NMP) is used for the electrode material as a diluent, polyvinylidene fluoride, for example, is added thereto as a thickener. If water is used for the electrode material as a diluent, carboxylmethyl cellulose, for example, is used thereto as a thickener.

The process of producing the electrode plate includes a drying process of drying the electrode plate in which a slurry electrode material has been coated on a sheet-shaped current collector by using a squeegee or the like so as to have a predetermined thickness (generally, 20 μm or less). The production process further includes a rolling process of rolling the surface on which the electrode material is coated in the electrode plate after the drying process in order to make the electrode plate flat. Then, the electrode plate is completed. It should be noted that the following UACJ Corporation, “aluminum foil for lithium-ion battery”, [online], [searched on Apr. 20, 2017], internet <URL:http://www.uacj.co.jp/review/furukawasky/005/pdf/05_abst01.pdf> describes a current collector for an electrode plate of a lithium secondary battery (lithium-ion battery).

An electrode material constituting an electrode plate thermally shrinks during the drying process after being coated on the current collector. However, even if some distortion or breakage occurs in the electrode material on the current collector due to thermal shrinkage, if the thickness of the electrode material is thin, the distortion or breakage is resolved by the rolling process after the drying process, and a smooth and continuous coating film is formed in the thickness direction and the plane direction. Accordingly, battery characteristics are not greatly affected.

Meanwhile, although it is not limited to laminated batteries, batteries are always required to have large capacity. In order to achieve an increase in battery capacity, coating the slurry electrode material more thickly on the current collector is effective. However, the effect of the foregoing thermal shrinkage increases as the coating film becomes thicker. For that reason, cracks or breakage may occur in the surface of the coating film, for example.

If an attempt is made to minimize the distortion due to thermal shrinkage using the rolling process, the hard coating film after drying, which has greatly shrunk, is forcibly stretched, so that the effect of latent cracks in the coating film may further worsen. According to findings of this discloser, when the electrode material has a thickness of 80 μm or more, the impact of thermal shrinkage can no longer be ignored.

Reducing or eliminating thermal shrinkage of the electrode material becomes even more important in the manufacture of electrode plates for batteries that are actually on the market. Specifically, the drying process and the rolling process are performed in a state in which the electrode material has been coated on a long band-shaped current collector. The band-shaped electrode plate is rolled so as to allow the current collector side to be oriented in the center direction, and then the process proceeds to the next step. Accordingly, the band-shaped electrode plate is wound so as to be stretched in the direction opposite to the direction in which the electrode material shrinks, and thus cracks or breakage are more likely to occur. In the next process, the wound long electrode plate is flattened again and is cut to a predetermined size and shape as an electrode plate for individual batteries. The impact at the time of cutting may cause cracks or breakage in the thick and dried electrode material.

The thermal shrinkage of the electrode material is likely to occur particularly when the electrode material is coated on copper foil that is often used as a negative electrode current collector of a lithium secondary battery. Copper is softer than metal that is used for other current collectors such as stainless steel and aluminum. For this reason, when the electrode material is thickly coated on the current collector made of copper foil, the thin current collector is greatly deflected with the electrode material side inward as the electrode material thermally shrinks in the drying process. Then, in the rolling process, the electrode plate is rolled to repair the deflection, and the electrode plate is wound in the direction opposite to the deflection direction. In order to increase the thickness of the coating film and maintain the thickness of the battery itself as much as possible, it is inevitably necessary to thin the current collector. In that case, the effect of thermal shrinkage becomes even more noticeable, and battery performance may deteriorate as a result. This may happen even if the current collector is not copper foil but some other metal.

Accordingly, one objective of this disclosure is to provide an electrode plate and a battery capable of achieving an increase in capacity of a battery without causing cracks and chips even if the electrode material is thickly coated on the sheet-shaped current collector.

One aspect of this disclosure for achieving the foregoing objective is an improved electrode plate constituting a positive electrode or a negative electrode of a battery and having a flat plate shape. The electrode plate includes a sheet-shaped current collector made of metal foil coated with a slurry electrode material that contains an electrode active material, a conductive auxiliary agent, a binder, and propylene glycol alginate as a thickener.

In this electrode plate, the slurry electrode material may be a water-based electrode material using water as a diluent. The current collector may be copper foil.

In this electrode plate, the binder may be styrene-butadiene rubber (SBR). Also, the electrode material coated on the current collector may have a thickness of at least 80 μm but not more than 100 μm.

This disclosure covers batteries as well, and an improved battery according to one aspect of this disclosure includes an electrode body and a flat casing. The electrode body is formed by laminating a flat plate-shaped positive electrode plate and a flat plate-shaped negative electrode plate via a separator, the positive electrode plate being formed by disposing a positive electrode material containing a positive electrode active material on a sheet-shaped positive electrode current collector, the negative electrode plate being formed by disposing a negative electrode material containing a negative-electrode active material on a sheet-shaped negative electrode current collector. The electrode body is sealed inside the flat casing together with an electrolyte. At least one of the positive electrode plate and the negative electrode plate is the electrode plate according to this disclosure.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1A is a diagram illustrating a configuration of a laminated battery;

FIG. 1B is a diagram illustrating a configuration of a laminated battery;

FIG. 2A is a photograph showing a state of a coating film of an electrode plate;

FIG. 2B is a photograph showing a state of a coating film of an electrode plate; and

FIG. 3 is a diagram illustrating a result of a charge-discharge cycle test with respect to a lithium secondary battery including an electrode plate according to an embodiment of this disclosure.

### DESCRIPTION OF EMBODIMENTS

In describing embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Referring now to the drawings, wherein like reference numerals designate identical or corresponding parts throughout the several views thereof, an electrode plate and a battery according to embodiments of the present disclosure are described. As used herein, the singular forms “a”, “an”, and “the” are intended to include the plural forms as well, unless the context clearly indicates otherwise.

### Performance Requirements for Electrode Plates

As described above, if the thickness of the coating film of the electrode material on the sheet-shaped current collector is increased to achieve an increase in capacity of a battery including electrode plates, cracks in or breakage of the coating film easily occur due to thermal shrinkage during a drying process and a subsequent rolling process. Then, this discloser considered that if the electrode material after drying had high elasticity, cracks or breakage due to the rolling process could be minimized. Then, this discloser also considered that a thickener could be adopted in the electrode material instead of cellulose, which had been conventionally used. However, the electrode material contains an electrode active material, a conductive material, or a binder associated with viscosity of a material like a thickener, and thus the thickener is required to have no adverse effect on other materials contained in the electrode material. Moreover, ease of manufacture is also required, such that a thick coating film can be formed on the current collector by a process similar to the conventional process. In view of the manufacturing cost of an electrode plate, it is also necessary to take the cost and ease of procurement of the thickener into consideration. Moreover, in producing an electrode plate, higher health and safety standards and a reduced impact on the environment are also required. In this way, the performance requirements for the electrode plate involve not only an increase in capacity of the battery but also many other considerations.

### EMBODIMENTS

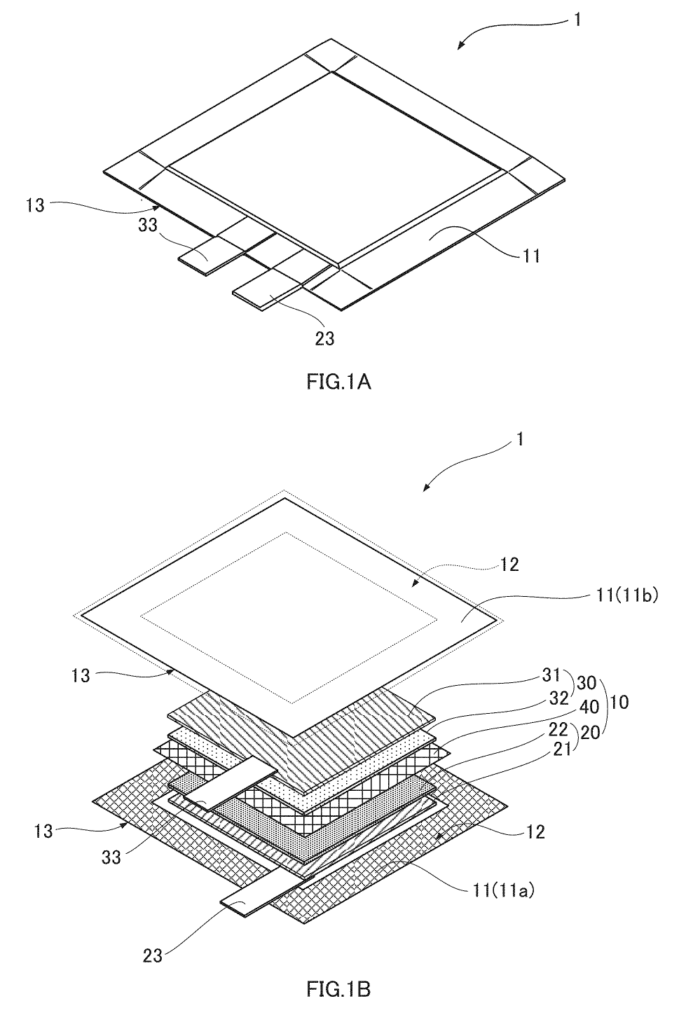

FIG. 1A and FIG. 1B each illustrate a laminated battery 1. FIG. 1A is an external view of the laminated battery 1, and FIG. 1B is an exploded perspective view illustrating an outline of an internal configuration of the laminated battery 1. As illustrated in FIG. 1A and FIG. 1B, the laminated battery 1 has a flat plate-shaped appearance, and a power-generating element is sealed internally inside a casing 11 formed by making laminated films 11a, 11b into a flat rectangular bag. In the laminated battery 1 illustrated here, a positive electrode terminal tab 23 and a negative electrode terminal tab 33 are led outward from the same side 13 of the rectangular casing 11.

The following description of a configuration of the laminated battery 1 is given with reference to FIG. 1B. FIG. 1B hatches some members and portions for easy distinction from other members and portions. As illustrated in FIG. 1B, the casing 11 is configured by welding peripheral edge regions 12 of two rectangular aluminum laminated films 11a, 11b, which are stacked on one another, by thermocompression bonding to seal the inside, the peripheral edge regions 12 being hatched or indicated by the dotted line frame in FIG. 1B.

In the casing 11, an electrode body 10 is sealed together with an electrolyte. The electrode body 10 is formed by laminating a sheet-shaped positive electrode plate 20 and a sheet-shaped negative electrode plate 30 via a separator 40. The positive electrode plate 20 is formed by applying and drying a slurry positive electrode material 22 containing a positive electrode active material on one main surface of a sheet-shaped positive electrode current collector 21 made of metal foil or a metal plate. The positive electrode terminal tab 23 is coupled to the positive electrode current collector 21. One end portion of the positive electrode terminal tab 23 is exposed to the outside of the casing 11, and another end portion thereof is coupled to a part of the positive electrode current collector 21 by ultrasonic welding or the like. The positive electrode material 22 is applied to a surface facing the separator 40 in the positive electrode current collector 21. As the positive electrode active material, manganese dioxide or the like can be employed as long as the laminated battery 1 is a lithium primary battery. If the laminated battery 1 is a lithium secondary battery, lithium cobalt oxide, lithium manganite or the like can be employed. Moreover, stainless steel foil, aluminum foil or the like can be employed as the positive electrode current collector 21.

The negative electrode plate 30 is formed by disposing a negative electrode material 32 containing a negative-electrode active material on one main surface of a sheet-shaped negative electrode current collector 31. A negative electrode terminal tab 33 is coupled to the negative electrode current collector 31 in the same manner as the positive electrode current collector 21 is, and one end portion of the negative electrode terminal tab 33 is exposed to the outside of the casing 11. The negative electrode material 32 may be formed by applying and drying a slurry material containing hard carbon if the laminated battery 1 is a lithium secondary battery. If the laminated battery 1 is a lithium primary battery, a negative-electrode active material itself made of lithium metal or lithium alloy can be used as the negative electrode material 32. Moreover, copper foil or the like can be employed as the negative electrode current collector 31. Then, the positive electrode material 22 of the positive electrode plate 20 and the negative electrode material 32 of the negative electrode plate 30 are disposed facing with each other via the separator 40 therebetween.

In the following description, the positive electrode plate 20 and the negative electrode plate 30 of the laminated battery 1 are collectively referred to as an electrode plate 100a. Moreover, the positive electrode material 22 and the negative electrode material 32 of the laminated battery 1 are collectively referred to as an electrode material 110a.

### Manufacturability

Alginate shows promise as a thickener for the electrode material 110a to meet various performance requirements for the electrode plate 100a. Alginic acid is a substance contained in various algae. It is an acid substance in which a carbonyl group is in the form of a free acid, and is usually insoluble in water. However, the alginate obtained by adding alkali to alginic acid to be neutralized is often widely used, for example, by being added to food as a thickener or an emulsifier. Accordingly, a thickener made of alginate is safe, environmentally friendly, low-cost, and easy to procure. Thus, a slurry electrode material 110a was prepared using any one of propylene glycol alginate (alginic acid ester), potassium alginate, sodium alginate, ammonium alginate, and calcium alginate as a thickener. Specifically, using water as a diluent, hard carbon, which is an electrode active material, acetylene black (AB), which is a conductive auxiliary agent, styrene-butadiene rubber (SBR), which is a binder, and the foregoing various alginate thickeners were mixed in amass ratio of 90:5:4:1, respectively, and kneaded. That is, various electrode materials 110a differing only in the type of thickener were prepared. As a result, the electrode material 110a using propylene glycol alginate as a thickener became slurry, whereas the other electrode materials 110a using alginate other than propylene glycol alginate each turned into a gel and aggregated, and did not become slurry. This is likely because the SBR has been acidified due to binding of side chains of the SBR to the alginate in a case of alginate other than the propylene glycol alginate. If a lot of water diluent is used, the electrode material can be coated. However, this does not dissolve agglomerates, and thus, for example, the coating film has an uneven surface. Accordingly, it is difficult to form a smooth coating film with such a material. If it is possible to add some process or to allow the electrode material to separately contain some additive that suppresses aggregation, there is a possibility that the electrode material becomes slurry even with alginate other than propylene glycol alginate. However, if a new process or other additives are added, the manufacturing cost increases. In contrast, if propylene glycol alginate is used as a thickener, the negative electrode material 32 can be produced without adding a new process or other additives. Propylene glycol alginate is inexpensive and is also easily procured, thus enabling reduction of cost.

### Coating Test

Next, the electrode plate 100a according to an embodiment of this disclosure was prepared, and a state of the coating film of the electrode material 110a of the electrode plate 100a was observed. Moreover, an electrode plate 100b according to a comparative example was prepared, and a state of the coating film of the electrode material 110b in the electrode plate 100b was observed. The electrode plate 100b according to the comparative example differs from the electrode plate 100a only in the type of thickener. Specifically, the electrode plates 100a and 100b were prepared by coating the electrode materials 110a and 110b each having the foregoing composition (i.e., hard carbon:AB:SBR:thickener=90:5:4:1) on copper foil 102 having a thickness of about 20 μm, so as to have a thickness of 200 μm, and by drying the coating film with hot air of, for example, 110° C. to 120° C. The thickener contained in the electrode material 110a is propylene glycol alginate, and the thickener contained in the electrode material 110b is carboxymethyl cellulose (CMC).

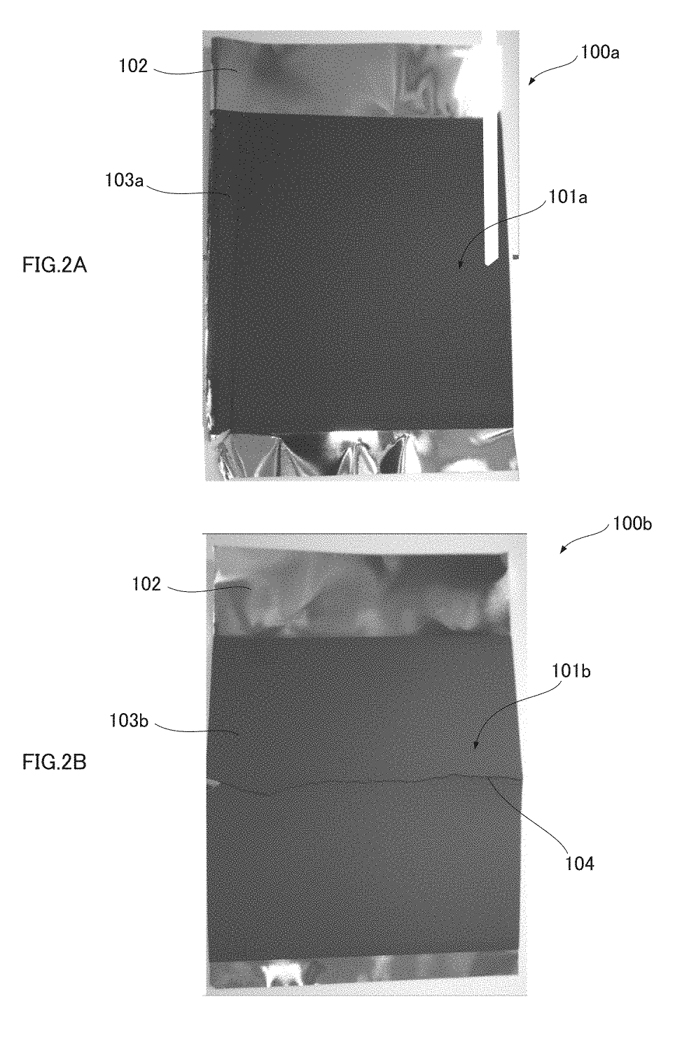

FIG. 2A and FIG. 2B illustrate states of the coating films of the electrode plate 100a according to the embodiment and the electrode plate 100b according to the comparative example, respectively. FIG. 2A is a photograph of a coated surface 101a of the electrode plate 100a according to the embodiment, and FIG. 2B is a photograph of a coated surface 101b of the electrode plate 100b according to the comparative example. As illustrated in FIG. 2A and FIG. 2B, it can be seen that the copper foil 102, which is a current collector, of the electrode plate 100a according to the embodiment and of the electrode plate 100b according to the comparative example wrinkles due to thermal shrinkage of the electrode materials 110a and 110b. However, as illustrated in FIG. 2A, it can be seen that, even though the copper foil 102 wrinkles in the electrode plate 100a according to the embodiment, the coated surface 101a does not have cracks and chips, and a smooth coating film 103a is formed. In contrast, in the electrode plate 100b according to the comparative example, a deep crack 104 occurs across the coated surface 101b in a thickness direction of the coating film 103b as illustrated in FIG. 2B.

### Battery Characteristics

Next, a laminated battery 1a according to the embodiment including the electrode plate 100a according to the foregoing embodiment as a negative electrode plate 30a, and a laminated battery 1b according to the comparative example including the electrode plate 100b according to the foregoing comparative example as a negative electrode plate 30b were prepared to examine respective charging and discharging characteristics. The laminated battery 1a and the laminated battery 1b are both lithium secondary batteries.

The only difference between the laminated battery 1a and the laminated battery 1b is use of the negative electrode plate 30a or the negative electrode plate 30b. The other configurations are identical to those of the laminated battery 1 illustrated in FIG. 1.

In other words, the laminated battery 1a according to the embodiment includes the casing 11, the electrode body 10a, the positive electrode terminal tab 23 and the negative electrode terminal tab 33, and the electrode body 10a includes the positive electrode plate 20, the separator 40 and the negative electrode plate 30a. It should be noted that the negative electrode plate 30a includes the negative electrode current collector 31 and the negative electrode material 32a, and corresponds to the foregoing electrode plate 100a. The negative electrode material 32a contains propylene glycol alginate as a thickener.

In contrast, the laminated battery 1b according to the comparative example includes the casing 11, the electrode body 10b, the positive electrode terminal tab 23 and the negative electrode terminal tab 33, and the electrode body 10b includes the positive electrode plate 20, the separator 40 and the negative electrode plate 30b. The negative electrode plate 30b includes the negative electrode current collector 31 and the negative electrode material 32b, and corresponds to the foregoing electrode plate 100b. The negative electrode material 32b does not contain propylene glycol alginate but contains CMC as a thickener.

In the positive electrode material 22, lithium cobalt oxide (LiCoO2: hereinafter, also referred to as LCO) was used as a positive electrode active material. Then, LCO, artificial graphite as a conductive agent and a binder made of polyvinylidene fluoride were mixed in a mass ratio of 90:7:3, respectively, to be kneaded by further using NMP, thus obtaining slurry. Then, the positive electrode material 22 was applied to the positive electrode current collector 21 made of stainless steel foil and dried to produce the positive electrode plate 20. Moreover, in the negative electrode plate 30b according to the comparative example, although the crack 104 appeared in the electrode plate 100b after drying as illustrated in FIG. 2B, the crack 104 of the coated surface 101b was repaired in the subsequent rolling process, so that the electrode plate 100b in which the crack 104 was not generated at least on the surface was used.

Next, the positive electrode terminal tab 23 was attached to the positive electrode current collector 21 in the foregoing positive electrode plate 20. Furthermore, the negative electrode terminal tab 33 was attached to the negative electrode current collector 31 in the negative electrode plate 30a. Then, the positive electrode plate 20 and the negative electrode plate 30a were laminated together, for example, via the separator 40 made of polyolefin, and press-bonded to form the electrode body 10a.

Similarly, the positive electrode plate 20 to which the positive electrode terminal tab 23 was attached and the negative electrode plate 30b to which the negative electrode terminal tab 33 was attached were laminated together, for example, via the separator 40 made of polyolefin, and press-bonded to form the electrode body 10b.

The electrode body 10a was sealed together with electrolyte in the casing 11 made of the laminated films 11a, 11b to complete the laminated battery 1a. Similarly, the electrode body 10b was sealed together with electrolyte in the casing 11 made of the laminated films 11a, 11b to complete the laminated battery 1b.

As the electrolyte, one obtained by dissolving lithium hexafluorophosphate (LiPF₆) as a solute so as to have a concentration of 1 mol/L in a three-component solvent in which propylene carbonate, ethylene carbonate and diethyl carbonate are mixed, for example, in a mass ratio of 4:3:3 was used.

A charge-discharge cycle test that repeated charging and discharging was performed on the laminated battery 1a produced using the negative electrode plate 30a according to the embodiment and to the laminated battery 1b produced using the negative electrode plate 30b according to the comparative example. Then, the relationship between the number of charge/discharge cycles and discharge capacity was examined.

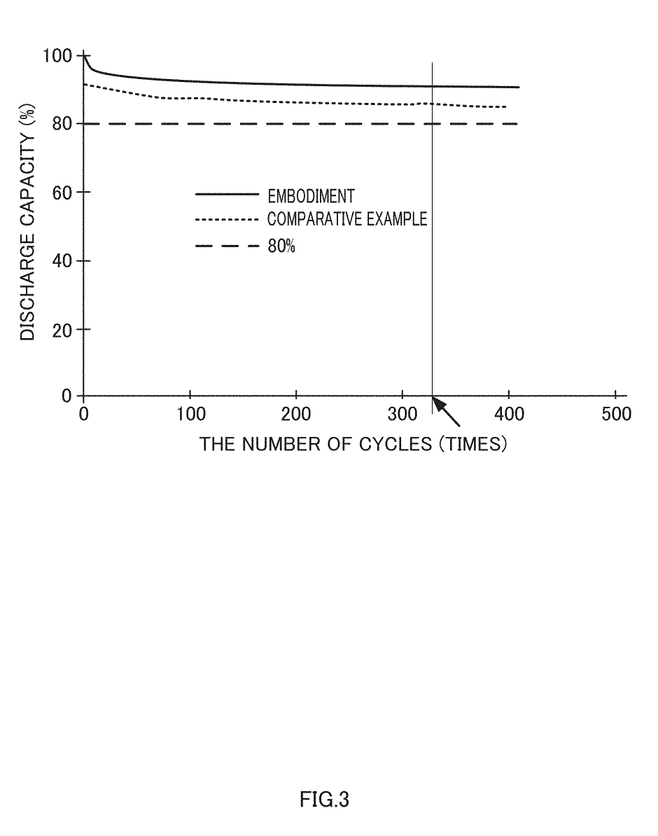

FIG. 3 illustrates a result of the charge-discharge cycle test for each sample. It should be noted that the discharge capacity illustrated in FIG. 3 is a relative value (%), and an initial discharge capacity before testing of the laminated battery 1a according to the embodiment using propylene glycol alginate as a thickener is set to 100%. The broken line of FIG. 3 shows 80% of the initial discharge capacity, which is an index of lithium secondary battery life.

As illustrated in FIG. 3, the laminated battery 1a according to the embodiment has a larger discharge capacity than that of the laminated battery 1b according to the comparative example using CMC as the thickener in the negative electrode material 32b. This may be attributed to the fact that the electrode plate 100b (negative electrode plate 30b) in the laminated battery 1b has cracks remaining in the coating film 103b caused by the rolling process even though the coated surface 101b does not appear to show breaks such as the crack 104, such that when the laminate battery 1b is compared with the laminated battery 1a, the discharge capacity decreases due to, for example, inhibition of ion conduction. In other words, the laminated battery 1b has not actually obtained an effect of increase of the discharge capacity expected by increasing the film thickness of the coating film 103b. In contrast, the laminated battery 1a is capable of reliably increasing the discharge capacity in accordance with the thickness of the coating film 103a.

Moreover, in the laminated battery 1a, the discharge capacity did not become 80% or less of the initial discharge capacity even after 400 or more charge/discharge cycles. Furthermore, from about the time the number of charge/discharge cycles exceeds 100, the decline in the discharge capacity of each of the laminated battery 1a and the laminated battery 1b starts to level off. However, the decline in the discharge capacity of the laminated battery 1b increases after the number charge/discharge cycles exceeds 300 as shown by an arrow in FIG. 3. In contrast, the declining tendency of the discharge capacity of the laminated battery 1a was small. Consequently, it is apparent that the laminated battery 1a is superior in cycle characteristics to the laminated battery 1b.

### Other Embodiments

The electrode plate 100a according to the embodiment of this disclosure is applicable to both the positive electrode plate 20 and the negative electrode plate 30. It should be noted that, in the electrode plate 100a according to the foregoing embodiment, a slurry electrode material 110a containing propylene glycol alginate has been prepared with water as a diluent. The alginate is used as a food additive, and by using the alginate in the water-based electrode material 110a the effects of thermal shrinkage of the electrode material 110a can be more effectively minimized. Needless to say, the use of propylene glycol alginate as a thickener other than the water-based thickener has great advantages. For example, it has been found that propylene glycol alginate does not react with SRB, which is commonly used as a binder for the electrode material 110a but is susceptible to oxidation, and accordingly, the electrode material 110a does not aggregate. Thus, options for the binder to be included in the electrode material 110a can be widened. In other words, propylene glycol alginate has the advantage that it can be used with various binders in accordance with the target characteristics without having to take into account any interaction with the binder.

The positive electrode current collector 21 constituting the positive electrode plate 20 according to the embodiment of this disclosure and the negative electrode current collector 31 constituting the negative electrode plate 30 are not limited to copper foil. With stainless steel foil or aluminum foil as well, which are harder than copper foil, if the positive electrode current collector 21 and the negative electrode current collector 31 themselves are made thinner, or the electrode material 110a is thickly coated, deformation due to thermal shrinkage of the electrode material 110a may occur in the same manner as with copper foil.

The electrode plate 100a according to the embodiment of this disclosure can be broadly applied not only to the laminated battery 1 and 1a using the laminated films 11a and 11b for the casing 11, but also to a battery including a flat casing. For example, the electrode plate 100a can be applied to a battery including a hard casing made of molded plastic or the like. Needless to say, the present disclosure is also applicable to a variety of other batteries, whether primary batteries or secondary batteries, as long as the battery includes the electrode plate 100a formed by applying the slurry electrode material 110a on the sheet-shaped current collectors 21, 31 such as metal foil.

According to the electrode plate 100a of this disclosure, even if the electrode material 110a is thickly coated on the sheet-shaped current collectors 21 and 31, cracks and chips do not occur in the electrode material 110a, thus increasing the capacity of the battery using the electrode plate 100a. Consequently, the battery according to this disclosure succeeds in having a large capacity.

The above-described embodiments are intended to facilitate an understanding of the present disclosure and are not in any way to be construed as limiting this disclosure. These embodiments may be modified and improved without departing from the scope of the disclosure, and equivalents thereof are also encompassed therein.

What is claimed is:

1. An electrode plate constituting a positive electrode or a negative electrode of a battery and having a flat plate shape, the electrode plate comprising:
a sheet-shaped current collector made of metal foil; and
a slurry electrode material coated on the current collector and containing an electrode active material, a conductive auxiliary agent, a binder, and a thickener,
the thickener being propylene glycol alginate.

2. The electrode plate according to claim 1, wherein
the slurry electrode material is a water-based electrode material using water as a diluent.

3. The electrode plate according to claim 1, wherein
the current collector is copper foil.

4. The electrode plate according to claim 2, wherein
the current collector is copper foil.

5. The electrode plate according to claim 1, wherein
the binder is styrene-butadiene rubber (SBR).

6. The electrode plate according to claim 2, wherein
the binder is styrene-butadiene rubber (SBR).

7. The electrode plate according to claim 3, wherein
the binder is styrene-butadiene rubber (SBR).

8. The electrode plate according to claim 4, wherein
the binder is styrene-butadiene rubber (SBR).

9. The electrode plate according to claim 1, wherein
the electrode material coated on the current collector has a thickness of 80 μm or more and 200 μm or less.

10. The electrode plate according to claim 2, wherein
the electrode material coated on the current collector has a thickness of 80 μm or more and 200 μm or less.

11. The electrode plate according to claim 3, wherein
the electrode material coated on the current collector has a thickness of 80 μm or more and 200 μm or less.

12. The electrode plate according to claim 4, wherein
the electrode material coated on the current collector has a thickness of 80 μm or more and 200 μm or less.

13. The electrode plate according to claim 5, wherein
the electrode material coated on the current collector has a thickness of 80 μm or more and 200 μm or less.

14. The electrode plate according to claim 6, wherein
the electrode material coated on the current collector has a thickness of 80 μm or more and 200 μm or less.

15. The electrode plate according to claim 7, wherein
the electrode material coated on the current collector has a thickness of 80 μm or more and 200 μm or less.

16. The electrode plate according to claim 8, wherein
the electrode material coated on the current collector has a thickness of 80 μm or more and 200 μm or less.

17. A battery comprising:
an electrode body formed by laminating a flat plate-shaped positive electrode plate and a flat plate-shaped negative electrode plate via a separator, the positive electrode plate being formed by disposing a positive electrode material containing a positive electrode active material on a sheet-shaped positive electrode current collector, the negative electrode plate being formed by disposing a negative electrode material containing a negative-electrode active material on a sheet-shaped negative electrode current collector; and
a flat casing in which the electrode body is sealed together with an electrolyte,
at least one of the positive electrode plate and the negative electrode plate being the electrode plate according to claim 1.
